(19) United States
(12) Patent Application Publication
(10) Pub. No.: US 2013/0093871 A1
(43) Pub. Date: Apr. 18, 2013

(54) OMNIDIRECTIONAL SUPER-RESOLUTION MICROSCOPY

(71) Applicants: Andreas G. Nowatzyk, San Jose, CA (US); Daniel Farkas, Los Angeles, CA (US)

(72) Inventors: Andreas G. Nowatzyk, San Jose, CA (US); Daniel Farkas, Los Angeles, CA (US)

(21) Appl. No.: 13/276,206

(22) Filed: Oct. 18, 2011

(51) Int. Cl. G02B 21/06; H04N 7/18

(52) U.S. Cl. 348/79; 348/E07.085

(57) ABSTRACT

A microscopy method and apparatus includes placing a specimen to be observed adjacent to a reflective holographic optical element (RDOE). A beam of light that is at least partially coherent is focused on a region of the specimen. The beam forward propagates through the specimen and is at least partially reflected backward through the specimen. The backward reflected light interferes with the forward propagating light to provide a three dimensional interference pattern that is at least partially within the specimen. A specimen region illuminated by the interference pattern is imaged at an image detector. Computational reconstruction is used to generate a microscopic image in all three spatial dimensions (X,Y,Z), simultaneously with resolution greater than conventional microscopy.

### BACKGROUND

1. Field

The present disclosure relates to microscopy, and particularly relates to super-resolution imaging microscopy in three dimensions.

2. Description of Related Art

Many of the features of interest in the fluorescence microscopy of cells are not resolved by a conventional optical microscope. This represents a fundamental barrier to progress, for example, in cancer research where imaging is used to study changes in cytoskeletal, membrane and chromosome structure, and to visualize changes in DNA, such as patterns of methylation. Super-resolution techniques allow the capture of images with a higher resolution than the classical diffraction limit. The recent proliferation of super-resolution methods reflects the recognition of this need. A category of super resolution techniques, known as “functional,” uses clever experimental techniques and known limitations on the matter being imaged to reconstruct a super-resolution image. Current approaches to overcome the Rayleigh limit either modify the signal that is emitted from the sample under investigation (Stimulated Emission Depletion (STED) microscopy, saturated excitation (SAX) microscopy, Scanning Photoemission Microscopy (SPEM), REversible Saturable OpticaL Fluorescence Transitions (RESOLFT), Photoactivated Localization Microscopy (PALM), and others) or increase the numerical aperture, most notably 4π and standing wave microscopy. While some methods have reported resolutions down to 8 nm, their practicality is severely hampered by the need for special fluorophores and/or extreme illumination light intensities, while the other methods may generally requires thin specimens.

To date, none of these methods have been found very practical for routine research or to image intracellular structures, nor can they be used with non-fluorescence imaging.

Standing waves have also been used with total internal reflection microscopy to improve lateral resolution, but this approach is often limited to one very thin section of the specimen.

In its simplest embodiment, in standing wave microscopy a mirror is placed directly behind the sample in an epi-fluorescence microscope. The sample is illuminated through the microscope objective lens. The light passes through the sample under investigation and is reflected back towards the objective lens by the mirror behind the sample. Thus the illumination light is traversing the sample twice, once from the objective lens towards the mirror and once in the opposite direction. If the distance from the sample to the mirror is less than half of the coherence length of the illumination light, an interference pattern that is periodic along the optical (Z) axis will be observed.

The important property of this interference pattern is that its period is approximately half of the wavelength of the excitation light. In standing wave microscopy, this property is used to increase the axial resolution of the microscope. The Fast Fourier Transform (FFT) of the Point Spread Function (PSF) is the optical transfer function (OTF), which is shown in FIG. 1A. By taking three images with the interference pattern shifted by −90, 0, and +90 degrees, it is possible to separate the up- and down-shifted Fourier component in the OTF and to undo this aliasing. FIG. 1B shows the PSF of a standing wave microscope, which is the product of the PSF of the objective lens and the axial interference pattern. Resolution along the Z-axis down to 35 nm has been demonstrated, provided that the axial extent of the sample does not exceed one period of the interference pattern.

Standing wave microscopy has been demonstrated by using a second illumination path with a second, matched objective lens in the position of the condenser instead of the mirror mentioned above. This configuration is more symmetric which allows better control of the interference pattern. It also allows a number of refinements. However, it does require a substantial modification of the microscope. It is also not easy to maintain stability along both illumination paths to within a fraction of the excitation wavelength. In practice, this setup suffers from many of the difficulties that plague 4π microscopy. Standing wave microscopy can be combined with other microscopy methods, such as two-photon excitation and confocal microscopy to further improve the resolution along the z-axis and to resolve ambiguities that stem from the periodic nature of the interference pattern.

The primary limitation of standing wave microscopy sterns from the fact that the interference pattern is produced by two counter-propagating planar or nearly planar wave-fronts. Thus the interference pattern is periodic along the Z-axis only and has no significant structure in the X and Y axis. Therefore only the resolution along the Z-axis is improved, while the resolution along the X and Y axis remains unchanged. Other problems arise simply from the aliasing along the Z axis which limits sample thickness, the stability requirements, the need for closely match microscope objectives, the extensive modifications to the microscope and the need for a symmetric sample preparation between two cover-slips.

### SUMMARY

In an aspect of the disclosure, a microscopy method includes placing a specimen to be observed adjacent to a reflective diffractive optical element (RDOE). A beam of light that is at least partially coherent is focused on a region of the specimen. The beam forward propagates through the specimen and is at least partially reflected backward through the specimen. The backward reflected light interferes with the forward propagating light to provide a three dimensional interference pattern that is at least partially within the specimen. A specimen region of the interference pattern is imaged at an image detector.

In a further aspect of the disclosure, an apparatus for omnidirectional super-resolution includes a reflective diffractive optical element (RDOE) configured to reflect and diffract illuminating light, and to contact a first side of a liquid specimen having the first side and a second side, wherein the specimen contains one or more object features, a coarse positioning stage coupled to the RDOE, a fine positioning stage coupled to the coarse positioning stage and RDOE, a light source configured to illuminate and pass light through the specimen from the second side; and a camera configured to capture a one or more digital images of light reflected and diffracted from the RDOE and passing back through the specimen.

### BRIEF DESCRIPTION OF THE DRAWINGS

FIG. 1A illustrates an optical transfer function (OTF) provided by a plane mirror standing wave microscope.

FIG. 1B illustrates a point spread function (PSF) provided by the microscope of FIG. 1A.

FIG. 2 illustrates a conceptual omnidirectional standing wave microscope in accordance with an aspect of the disclosure.

FIG. 3 illustrates a conceptual processor system configured with the omnidirectional standing wave microscope of FIG. 2, in accordance with an aspect of the disclosure.

FIG. 4 illustrates a conceptual apparatus for super-resolution optical microscopy in accordance with an aspect of the disclosure.

FIGS. 5A-5F illustrate the 3-D resolution enhancement that may be obtained in operation of a OSW microscope equipped with an RDOE for super-resolution optical microscopy in accordance with an aspect of the disclosure.

FIG. 6 is a flow diagram describing a method for obtaining an image using super-resolution optical microscopy in accordance with an aspect of the disclosure.

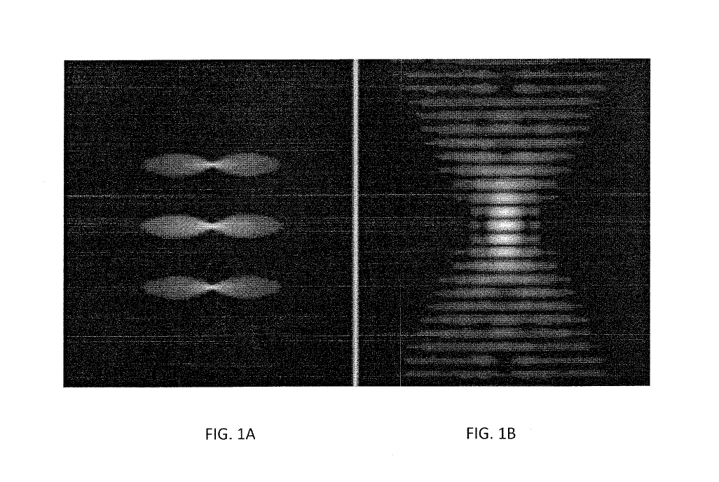

### DETAILED DESCRIPTION

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element. In addition, when a first element is “coupled” to a second element, the first element may be directly connected to the second element or the first element may be indirectly connected to the second element with intervening elements between the first and second elements.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower” can therefore encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

A structure and method is disclosed to achieve super-resolution in imaging microscopy by extending standing wave microscopy (SWM) into three dimensions. Unlike the conventional SWM, the new device will achieve super-resolution in all three dimensions using a simple and practical optical technique, with no special requirements regarding fluorophores or light sources, and with image acquisition times potentially allowing for live-cell imaging. A set of fluorescence images can be recorded using a regular CCD camera as a piezo stage is translated through a predefined nano-position 3-D step sequence. The image set can then be processed using high-speed sparse matrix processing algorithms to generate a 3-D super-resolution image. The approach relies on transforming the optical resolution problem into a well defined computational problem.

Omnidirectional Standing Wave Microscopy (OSWM) may provide a means of overcoming the conventional resolution limit of an optical microscope to obtain super-resolution in all three dimensions simultaneously. In an aspect of the disclosure, the mirror in an implementation of structured illumination epi-fluorescence microscopy (to produce a standing wave, resulting in axial fringes of illumination) is replaced by an inexpensive, disposable reflective diffractive optical element (RDOE). This holographic grating imposes a rich 3-D structure onto the interference pattern (“structured standing wave”, SSW) that is generated throughout the sample volume. OSWM uses this effect to subdivide the PSF of an otherwise unmodified epi-fluorescence microscope. By moving the reflective element via piezo-actuators in a controlled fashion, a series of images may be obtained by a digital camera and stored in a computer memory. The images may be computationally combined by a computer processor into one high-resolution 3-D image of the sample. Unlike previously demonstrated standing wave microscopy, OSWM can provide super-resolution in all three dimensions using a simple and practical optical technique. This approach transforms the optical resolution problem into a well defined computational problem. A 3-D reconstruction algorithms can be developed from existing 3-D reconstruction (“inverse” Radon transform) methods and implemented using high speed graphics processors to provide nearly real time 3-D images with spatial resolution below the Rayleigh limit.

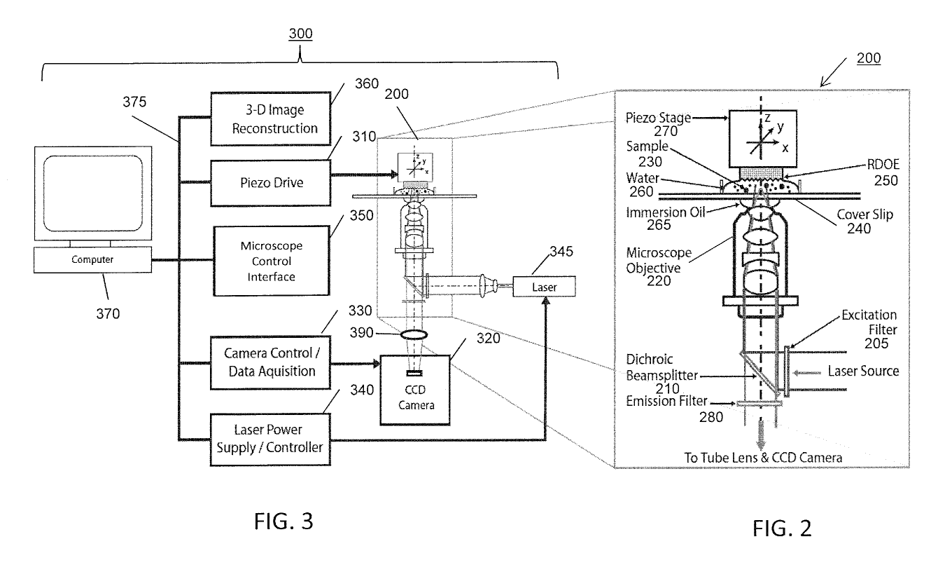

In an aspect of the disclosure, an embodiment of an OSWM system 200 is shown in FIG. 2. Light from a stabilized laser source (not shown) may be coupled, respectively, via an excitation filter 205 (optional), a dichroic beam splitter 210 and a microscope objective 220 to a cover slip 230 supporting a sample 240 and a RDOE 250 where the structured standing wave is generated by optical interference of the forward and reflected/diffracted light waves. The filters and beam splitter may be optimized for the laser and fluorescence wavelengths. The sample may be in an aqueous solution 260, which forms a contacting interface at the RDOE/sample interface. Immersion fluid 265 (e.g., water and/or oil) may be used at the objective/cover slip interface. Both liquid interfaces may minimize reflection losses and increase the numerical aperture (NA), but this is not essential for the technique to work. The filters 205, 280 and beam splitter 210 may be optimized for the selected laser and fluorescence wavelengths.

Once the sample-bearing coverslip 240 has been positioned in the field of view of the microscope objective 220, a piezo stage 270 may be controlled to scan in a series of sequential steps in three dimensions. Images produced may be transmitted back through the dichroic beam splitter 210 and an emission filter 280 (optional) to an image detector/camera which may be, for example, a CCD or other type of camera 320 (as shown in FIG. 3), and is further discussed below. Interface optics 290 may be used to couple the OSWM system 200 to the camera 320.

FIG. 3 illustrates a conceptual controller/processor 300 coupled to the OSWM 200 to acquire images and reconstruct magnified 3-D images with spatial resolution below the Rayleigh limit. A piezo drive controller 310 is configured to step the piezo stage 270, moving the RDOE through a sequence of positions. At each position the image detector/camera 320 acquires an image, which is received by a data acquisition/camera controller 330. The image is provided by illumination of the sample space by a laser 345, where the laser 345 is controlled by a laser power supply/controller 340 coupled to the laser 345. A microscope control interface 350 controls generic microscope functions, including, but not limited to microscope objective focusing and sample coarse positioning.

Once the sample 230 has been positioned in the field of view of the OSWM 200, a piezo-scan sequence will be initiated and a set of images will be generated and stored for post processing by a 3-D image reconstruction engine 360, i.e., a computer program of instructions, which has received the image set from the data acquisition/camera controller 330. Each image file will also contain position information of the piezo stage 270 for the reconstruction by the 3-D image reconstruction engine 360.

A central processor 370, which may be, for example, a personal computer, is configured to run a program to control the piezo drive controller 310, image detector/camera 320 (via the data acquisition/camera controller 330), laser power supply/controller 340, microscope control interface 350, and image reconstruction engine 360 over a communications interface 375. The communication interface 375 may be a direct link, whether electrical, optical or wireless. Alternatively, the communications interface may be a network having one or more access nodes to which the elements in FIG. 3 may connect from different locations to be in communications with the central processor 370.

The piezo drive controller 310 is coupled to the piezo stage 270 and controlled the motion and position of the piezo stage 270. The data acquisition/camera controller 330 is coupled to the camera 310 and controls and receives images from the

Like the mirror in a conventional standing wave microscope, the RDOE 250 reflects the excitation light back towards the microscope objective lens 220 and creates an interference pattern with the incident excitation wavefront throughout the sample volume viewed in the aperture of the microscope objective lens 220. However, unlike the interference pattern created by a plane mirror, the interference pattern created by the RDOE 250 has a complex, three-dimensional structure with sharp contrast in all three dimensions. This interference pattern is a function of the RDOE position that can be moved over the sample volume in a controlled, preset fashion by the piezo stage 270 under the control of the piezo drive controller 310.

A main objective in forming a profile of surface topography of the RDOE 250 is to optimize the spatial contrast in all three directions. Thus, while details of the topography may vary, a pattern of the RDOE 250 having a lateral pitch on the order of one wavelength and a modulation depth on the order of approximately one half of the wavelength can produce usable interference patterns. A RDOE 250 having a periodic deformation structure on this scale may be provided by imprint stamping a plastic substrate with a pre-formed hard master, followed by coating the plastic with a metal for high reflectivity. Other methods may be used to produce the RDOE 250, but imprint stamping enables low cost manufacture of large quantities of the RDOE 250 to uniform tolerances, so that the RDOE 250 is a disposable nontoxic commodity that can be directly exposed to biological aqueous media.

The structure of the RDOE 250 may consist of patterns that produce pseudo-random interference profiles throughout the volume of the sample 240. However structures that are periodic in two orthogonal dimensions may greatly simplify the image reconstruction. For example preliminary tests have shown that a rectangular array of pyramidal reflectors produces satisfactory results. In general, the RDOE 250 may be optimized to maximize the high spatial frequency components perpendicular to the optical axis, i.e., substantially in the plane of the cover slip 230. This needs to take the excitation wavelength, the microscope geometry and the realizable excitation wave front for a specific microscope objective 220 into account. In most practical embodiments, the excitation wave front will be converging on a point behind the sample, which is due the fact that the light traverses the objective lens which has a very short focal length. The RDOE 250 has to take this converging beam path into account to achieve good interference contrast, which depends on the intensity of the reflected illumination light is approximately equal to the incident light. This intensity modulation ratio is preferably achieved locally, not globally over the entire sample volume. This is either achieved by minimizing the distance between the sample and the RDOE 250 or by using an RDOE that focuses light like a spherical mirror, but with small distortions to create the required structure.

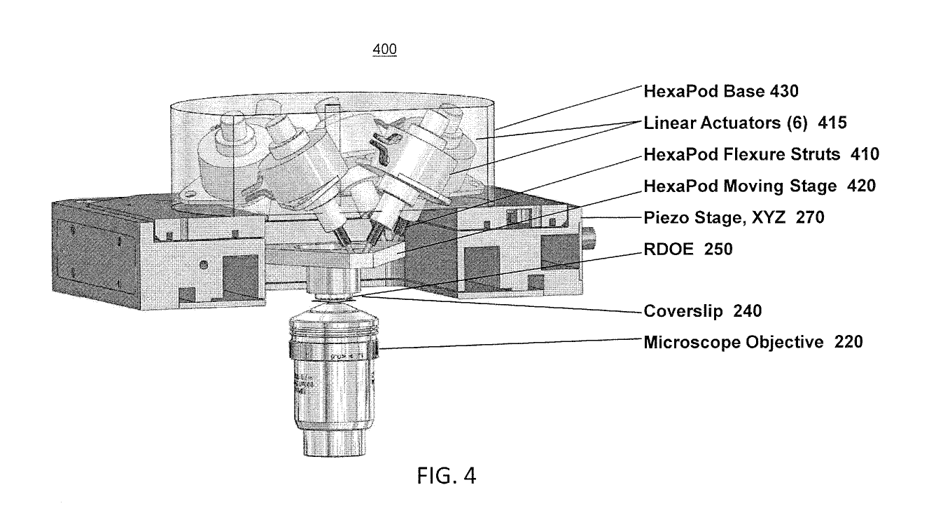

FIG. 4 illustrates some elements of FIG. 2 in more detail. For the structured standing wave to be positioned optimally above the sample, 6 degrees of freedom (DOF) of relatively gross motion are required for the RDOE. Additionally 3 orthogonal degrees of freedom of fine linear motion are needed to both position and scan the RDOE relative to the sample. The RDOE may be positioned with respect to the coverslip 240, which supports the specimen, by a set of hexapod flexure struts 410, wherein each hexapod flexure strut is driven by a linear actuator 415, to manipulate and position a hexapod moving stage 420. The hexapod moving stage 420 supports the RDOE 250. The linear actuators 415 are mounted in a hexapod base 430, which is attached to the piezo stage 270. The linear actuators 415 and hexapod flexure struts provide coarse positioning, while the piezo stage provides fine positioning for stepped image acquisition. This positioning of the RDOE above the sample occurs relative to stage on the microscope. Physik Instrumente P-561.3CD stage (Karlsruhe, Germany) is an example of a linear 3-axis fine motion control stage. Physik Instrumente N-515K stage (Karlsruhe, Germany) is an example of a 6-axis Piezo Hexapod.

In SWM, the interference pattern has a very regular structure that leads to a relatively simple, direct mathematical formulation that can be solved directly yielding an axial spacing between consecutive intensity maxima in the fringe pattern. The computational requirements for OSW microscopy (OSWM) are much greater that those for ordinary standing wave microscopy (SWM).

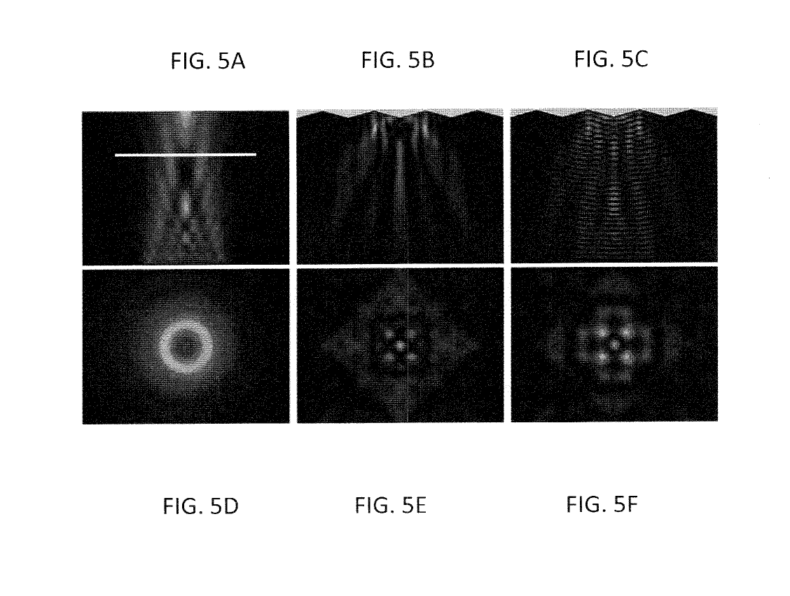

FIGS. 5A-5F illustrate the 3-D resolution enhancement that may be obtained in operation of a OSW microscope equipped with an RDOE. FIG. 5A is the intensity distribution in the XZ plane of an illumination beam that originates from a circular aperture at the bottom of the panel. FIG. 5B shows the intensity distribution of the beam when it is reflected by the RDOE. In the illustrated example, the RDOE is an array of pyramidal reflectors. FIG. 5C shows the interference pattern that is created by the two, counter-propagating wave-fronts. As would be expected from the preceding discussion, an axial intensity modulation is produced that has a period of approximately one half of the excitation wavelength. FIGS. 5D-5F show the intensity distribution in the XY plane, at a position that is indicated by the white line in FIG. 5A for the intensity distributions shown in FIGS. 5A-5C, respectively. It is important to note that, unlike in ordinary standing wave microscopy, there is a rich structure in the X-Y plane with features on the order of one half of the excitation wavelength.

The computational reconstruction of an image of an object of molecular scale may exploit established techniques for tomographic inverse problems such as CT & PET, each system being characterized by its system matrix. Whereas in CT each row of the system matrix represents a line integral through the image, in OSWM it represents the microscope's PSF weighted by the interference pattern. The system matrix for OSWM is very sparse and localized due to the fact that the PSF of the microscope collects light only from a small volume of the sample for each pixel of the image collected by the imaging detector (CCD camera). A primary challenge for the image reconstruction algorithm is to store the system matrix efficiently. Because the system matrix lacks full translation invariance, OSWM reconstruction is a poor fit for the Fourier transforms often used to study CT mathematically. This leaves filtered back-projection (FBP) algorithms and algebraic methods. FBP is a common algorithm used in the tomographic reconstruction of clinical data. The FBP algorithms are attractive because of the low memory requirement; however developing appropriate filters may be difficult. Therefore an algebraic reconstruction based on a preconditioned conjugate gradient method is an alternative that may be used. The Algebraic Reconstruction Technique (ART) is an iterative algorithm for the reconstruction of a two-dimensional image from a series of one-dimensional angular projections (a sinogram), used in computed tomography scanning. In numerical linear algebra the reconstruction method is called the Kaczmarz method.

An optimized system matrix representation for super-resolution imaging computes its elements based on the two separate components, the PSF and the interference pattern. The PSF of the microscope may be considered to be identical for each pixel of the camera. It is possible to relax this assumption and parameterize the PSF to take the X/Y position of the pixel into account. In any event, the PSF is stored only once for the entire camera, not once for each pixel. The second component is the interference pattern, which is simply stored as a non-sparse 3-D array that may be constructed from a signal measured of the probe points during the calibration. It should be noted that this array has about the same number of elements as the reconstructed image and is not of the size of the system matrix. Thus the memory requirement for this representation is reasonably small.

The function to produce the non-zero values of the system matrix first enumerates the non-zero elements of the microscope PSF. The non-zero PSF elements are then multiplied with the value of the SSW interference pattern. This value is based on the voxel location and the position of the RDOE. After a simple coordinate transform, the intensity value is retrieved from the SSW array via linear interpolation. It may be practical to use fewer elements for the SSW array and better interpolation, for example, using a table-driven Lanczos re-sampling. The Lanczos filter is a windowed form of the sinc filter. The reconstruction of a 10 μm cube can require several days of computer time on a normal PC. However, this time can be greatly reduced by transforming the code to use floating-point accelerators. Currently, one platform is the GTX 590 series graphical processing unit (GPU) developed by NVIDIA that is supported by the CUDA software framework, and which is suitable for scientific codes like this OSWM reconstruction. Each GTX 590 GPU has 1024 cores, and several of these GPUs can be used together. It is estimated that OSWM reconstruction time may be reduced to a few minutes. Additionally, very fast advances in hardware and further customized software will potentially reduce this by another order of magnitude or more.

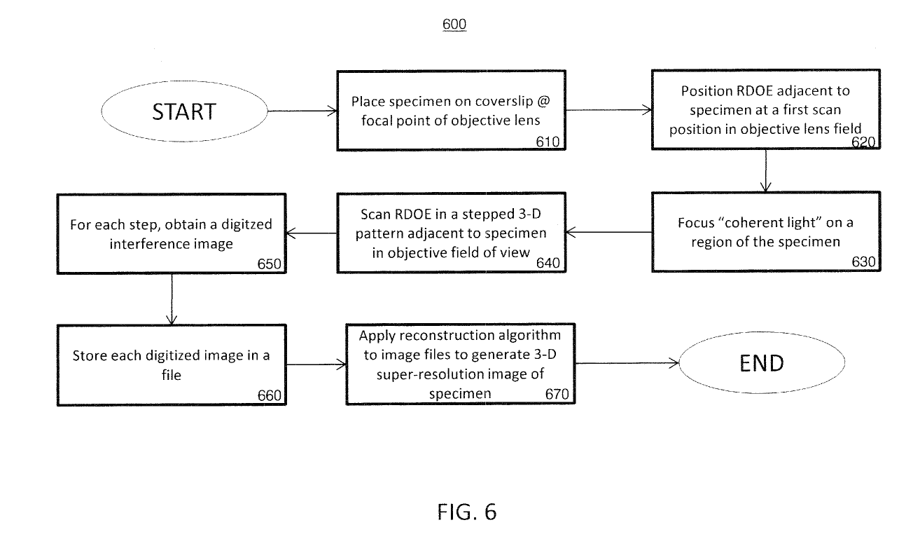

In a further aspect of the disclosure, FIG. 6 illustrates a method 600 of providing 3-dimensional (omnidimensional) super-resolution of magnified microscopic images. Method 600 begins with process block 610, in which a specimen (typically in aqueous solution is placed on a coverslip 240 at the focal point of the microscope objective 220.

In process block 620 the RDOE 250 may be positioned adjacent to the specimen at a first position prior to the start of a 3-D scan sequence. The aqueous solution may contact the RDOE 250, and the focal point may be substantially located in a volume of space containing the specimen between the coverslip 240 and the RDOE 250. The RDOE 250 may be positioned by control of a coarse positioning hexapod positioning system and a fine positioning piezo stage.

In process block 630, a coherent light source, such as a laser 345, may be focused on a region of the specimen in the field of the microscope objective 220. Provided the coherence length of the laser is greater than the interference path between the coverslip 240 and the RDOE 250, an interference pattern will be created by the coherent interference between the forward propagating laser light and the light reflected/diffracted from the RDOE 250.

In process block 640, the RDOE 250 may be scanned across a 3-D portion of the microscope objective field of view in programmed steps, where the motion is executed by the piezo stage 270. Position resolution may be on the order of tens of nanometers, or less.

In process block 650 an interference image is acquired by the camera 320 and digitized, and is then stored (in process block 660) in a file in memory associated with the computer 370.

In process block 670 a reconstruction algorithm is applied to the image files to generate a super-resolution image in 3-D of the specimen, ending the method. The resolution may be on the order of the piezo stage stepping resolution.

The 3-D image may be presented graphically in a manner substantially similar to reconstructed images acquired by PET, CAT and MRI scanning.

It may be appreciated that the apparatus and methods described herein may be applied to fast, automated image-based techniques to allow high-throughput screening of mammalian cells for sub-cellular structural information from the cytoskeleton, membranes and chromosomes, potentially with long-term benefits that include finding targets for treatment, observing and predicting responsiveness to therapy, and improving the use of cell models in drug development. An additional advantage of the disclosed methods uses in concert with the disclosed apparatus is that it can, in principle, incorporate approaches that yield even higher resolution fluorescence images, including multi-photon microscopy, STED microscopy, 4π solid angle imaging, Stochastic Optical Reconstruction Microscopy (STORM), PALM and others. While initial applications may be for biological and medical imaging, the super resolution fluorescence approach may also find applications in the rapidly growing nanomaterials area, for example in the development of advanced solar cells, battery membranes and nanoscale electronics components.

The various aspects of this disclosure are provided to enable one of ordinary skill in the art to practice the present invention. Modifications to various aspects of forming nanostructures to modify a Cu surface presented throughout this disclosure will be readily apparent to those skilled in the art of batteries, applications to other technical arts, and the concepts disclosed herein may be extended to such other applications. Thus, the claims are not intended to be limited to the various aspects of a lithium-ion battery presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A microscopy method, comprising:
providing a reflective diffractive optical element (RDOE);
placing a specimen to be observed adjacent to the RDOE;
focusing a beam of at least partially coherent light on a region of the specimen, wherein the beam forward propagates through the specimen and is at least partially reflected backward through the specimen from a reflecting surface;
interfering the backward reflected light with the forward propagating light to provide a three dimensional interference pattern that is at least partially within the specimen; and
imaging a magnified specimen region of at least a first portion of the interference pattern at an image detector.

2. The method of claim 1, further comprising step scanning the RDOE in three orthogonal dimensions to position the interference pattern throughout a selected volume of the specimen to acquire an image at each step a magnified region of at least a second portion of the interference pattern at the image detector.

3. The method of claim 1, further comprising transforming the plurality of acquired interference pattern images into a data representation of a spatial image of a portion of the specimen disposed within the region of the interference pattern.

4. The method of claim 3, wherein the transformation is based on an inverse Radon transform.

5. The method of claim 4, wherein the inverse Radon transform is based on a filtered back-projection technique.

6. The method of claim 4, wherein the inverse Radon transform is based on an algebraic reconstruction technique.

7. The method of claim 1, the imaging further comprising:
positioning the RDOE at an initial location relative to the specimen;
scanning the RDOE in a plurality of position steps over a three dimensional volume of the specimen containing a one or more object features;
acquiring by the image detector an image at each position of the interference pattern; and
processing the images acquired at each of the plurality of position steps to reconstruct a three dimensional image of the one or more object features.

8. The method of claim 7, wherein the positioning is obtained with a hexpod positioned.

9. The method of claim 7, wherein the scanning is obtained with a piezo stage.

10. The method of claim 7, wherein the processing comprises:
storing the images acquired at each of the plurality of position steps as a plurality of files of digital data in a memory readable by a computer processor; and
applying a reconstruction algorithim to obtain a transformation of the digital data in the plurality of files to generate a three dimensional image of the one or more object features.

11. An apparatus for omnidirectional super-resolution imaging, comprising:
a reflective diffractive optical element (RDOE) configured to reflect and diffract illuminating light, and to contact a first side of a liquid specimen having the first side and a second side, wherein the specimen contains one or more object features;
a coarse positioning stage coupled to the RDOE;
a fine positioning stage coupled to the coarse positioning stage and RDOE;
a light source configured to illuminate and pass light through the specimen from the second side; and
a camera configured to capture a one or more digital images of light reflected and diffracted from the RDOE and passing back through the specimen.

12. The apparatus of claim 11, further comprising a dichroic beam splitter configured to enable admittance of the illumination light and egress of the reflected and diffracted light.

13. The apparatus of claim 11, further comprising a microscope objective to focus the illuminating light within the specimen.

14. The apparatus of claim 11, further comprising an excitation filter coupled to the light source, wherein the excitation filter is selected on the basis of a one or more wavelengths of the light source.

15. The apparatus of claim 11, wherein the light source is a laser with a defined one or more wavelengths.

16. The apparatus of claim 11, further comprising an emission filter selected on the basis of a one or more wavelengths of light emitted in reflection from the RDOE and specimen.

17. The apparatus of claim 11, further comprising a microscope objective lens coupled to the light source and the camera.

18. The apparatus of claim 17, further comprising:
a coarse positioning controller to control the position of the coarse positioning stage;
a fine positioning controller to control the position of the fine position stage;
a power supply/controller to power and control the light source;
a data acquisition and camera controller to control the camera and receive the one or more digital images;
a microscope controller to control the microscope objective lens for focusing; and
a computer processor coupled to one of more of the coarse positioning controller, the fine positioning controller, the power supply/controller, the data acquisition and camera controller, and the microscope controller.

19. The apparatus of claim 11, further comprising a 3-D image reconstruction engine program of instructions executable on the computer processor, the 3-D image reconstruction engine configured to process the one or more digital images on the basis of the position of the stage corresponding to each digital image.
